(19) United States
(12) Patent Application Publication
(10) Pub. No.: US 2007/0225963 A1
(43) Pub. Date: Sep. 27, 2007

(54) Method to Process Instruction Requests for a Digital Hardware Simulator and Instruction Request Broker

(76) Inventors: Holger Horbach, Stutgart (DE); Johannes Koesters, Weil im Schoenbuch (DE); Klaus-Dieter Schubert, Schoenrich (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/550,443

(22) Filed: Oct. 18, 2006

(30) Foreign Application Priority Data
Sep. 12, 2005 (EP) 05111868.5

(51) Int. Cl. G06F 9/455

(52) U.S. Cl. 703/27

(57) ABSTRACT

The present invention relates to the processing of hardware simulator instruction requests. A request broker is processing high-level simulator instruction requests submitted by different drivers. A high-level instruction request comprises multiple simulator instructions. The request broker is receiving and splitting the requests into simulator instructions. The instructions are put in a request queue associated to the driver originating the request. The request broker is then processing the request queues in a round-robin fashion and submits the instructions in a queue to the simulator until a clock instruction needs to be submitted. Then the next queue is processed. When only clock instructions need to be submitted, the minimum number of clock cycles is determined and submitted in a new instruction to the simulator. This minimum number is then subtracted from the clock instructions in the queues, and the drivers are queried for new requests.

### BACKGROUND OF THE INVENTION

The present invention relates to a method to process instruction requests for a digital hardware simulator and an instruction request broker.

Success in the server industry is directly related to the features, quality, and development costs of a product, and the time it takes to deliver that product to the marketplace. For example, the system integration of an IBM eServer z990 began when a z990 book, which houses the main processors, memory, and I/O adapters, was installed in a z990 frame, an operating system was booted in the service element, and power was turned on. This initial system “bringup”, also referred to as post-silicon integration, is composed of three major steps: initializing the chips, loading embedded code (firmware) into the system, and starting an initial program load of an operating system.

These processes are serialized, and verification of the majority of the system components cannot begin until these steps are completed. Therefore it is important to shorten this critical time period by improving the quality of the integrated components through more comprehensive verification prior to manufacturing. One way to achieve this is to focus on the verification of the interaction between the hardware components and firmware by computer-based simulation. This is often referred to as hardware and software (HW/SW) co-simulation.

Verification of hardware and firmware first occurs independently and culminates in a pre-silicon system integration process, or virtual power-on. Such a virtual power-on approach of bridging hardware and firmware verification with the goal of optimizing system integration is described in K. -D. Schubert et al: “Accelerating system integration by enhancing hardware, firmware, and co-simulation”, IBM J. Res. & Dev., Vol. 48, No. 3/4, 2004. This approach is using a hardware emulator to accelerate the hardware simulation. Details for the use of this hardware emulator are described in J. Kayser et al: “Hyper-acceleration and HW/SW co-verification as an essential part of IBM eServer z900 verification”, IBM J. Res. & Dev., vol. 46, No. 4/5, 2002.

Every simulator provides a command interface that allows controlling the simulation. Often, an application programming interface is provided. The commands are also called the simulator instructions. The hardware simulation of discrete digital logic circuits typically follows the pattern: model access, model clocking, model access. In the model access step certain values in model entities such as signals or registers are either set or retrieved, and in the model clocking the model is stimulated for a number of clock cycles. For the model access step it is also said, that stimulus is applied to the model.

The entities in a simulation model that can be accessed via the simulator command interface are hereinafter called facilities of the model. The values that are set in the facilities are also called stimuli. The simulator commands that can be used to access the facilities are called the access instructions, and the simulator commands that can be used to simulate the model for a number of clock cycles are called the clock instructions. Programs that use the simulator interface to control the simulation via the access and clock instructions are called drivers.

For example, the U.S. patent application US 2003/0225561 A1 described an emulation-based event-wait simulator including a single application module to configure and command verification processes on a simulation model. As shown there in FIG. 1F, in this HW/SW deterministic co-simulation approach the control of the simulation changes frequently between the application module and the hardware emulator: Either the hardware model simulates clock cycles, or the application module is executed. Depending on its stimuli, the application module determines the number of clock cycles to be executed by the hardware emulator. Although only one application module is supported, it can comprise multiple program execution threads and the interactions with the software simulation are realized by multiple so-called transactor drivers.

For the virtual power-on process as described above, the assumption is that the hardware is imulated independently from the firmware. Only at certain points in time the firmware simulation needs to communicate with the hardware simulation to exchange and set values of facilities in the hardware model. Then at least one driver is used for this firmware simulation and at least another driver is used for the hardware simulation itself.

When using hardware accelerators and hardware emulators the simulation model executes simulation clock cycles without any driver and without any driver interaction with the simulator. The reason for this approach is the simulation performance penalty that is introduced by stopping the model simulation and performing a model access step. The maximum simulation performance of hardware accelerators and hardware emulators can only be achieved when the simulation/emulation is not interrupted for a large number of clock cycles since it takes quite some time to stop the accelerator hardware/emulator hardware and to start it again.

Especially, hardware accelerators and hardware emulators offer parallelism to the simulation. Some parts of the hardware model can operate quite independently from other parts of the hardware model. Such parts are processed by different parts of the hardware accelerator or the hardware emulator. Therefore it is common to use also different drivers for these different model parts. For example, when a computer system model is simulated one driver can be responsible for a processor subsystem in the computer system model and another driver can be responsible for the I/O (input/output) subsystem in the computer system model.

On the other hand, the simulator command interface allows to process only one command at a time. This creates a bottleneck with the inherent problem of mapping the real hardware behaviour to simulator commands that can be processed sequentially only whereas for the real hardware many activities can happen at the same time.

A scenario with multiple drivers is shown in FIG. 1. There are two drivers A and B that submit requests to a simulator or emulator 10 that processes a hardware model 20. Driver A submits the access instructions A-A1, A-A2, A-A4 and the clock instruction C-A3 in the sequence A-A1, A-A2, C-A3, and A-A4. The driver B submits the access instructions A-B1 and A-B3, and the clock instructions C-B2 and C-B4 in the sequence A-B1, C-B2, A-B3, and C-B4.

When using multiple drivers, these drivers operate independently from each other and have no means to synchronize with other drivers. The only requirement is that all the simulator instructions issued by one driver are processed by the simulator in the order they are issued by the driver. Therefore it is common that the drivers are synchronized by an additional software layer that handles the simulator instructions issued by the drivers and is always in control of the simulation; e.g. there are no callbacks or events as in the U.S. patent cited above.

This layer is called simulator request broker. The drivers submit their simulator instructions in form of simulator request to the simulator request broker. FIG. 2 illustrates such a scenario using the same drivers A and b, a request broker 30 and the same simulator instructions as in FIG. 1.

The simulator request broker is issuing clock instructions to the simulator in fixed intervals and processes the simulator instruction requests in a round-robin fashion. The simulator must have completed a request of one driver before the next request from another driver is being processed. Consequently, the requests of the different drivers are executed in a strictly serial manner, one after the other and in the sequence of their submission to the simulator request broker.

For example, in FIG. 2 there are highlighted two segments 1 and 2 in the stream of simulator instructions 31. Segment 1 comprises the clock instructions C-B3 and C-A3 in sequence, segment 2 comprises the clock instruction C-B1 and the access instructions A-A2 and A-A1 in the sequence A-A, C-B1, and A-A2. Segment 2 is submitted to the simulator 10 before segment 1.

In segment 1 the simulator 10 is clocked multiple times in sequence whereby the clock instructions of the two drivers A and B are executed subsequently. This is effectively causing subsequent access instructions of both drivers to wait before they can be submitted to the simulator 10. The time that these access instructions are postponed is the sum of the times that it takes to clock the model as requested by both drivers instead of the time it takes to clock the model as requested by just one of the drivers. In segment 2 access instructions of driver A are interrupted by a clock instruction of driver B.

Since the hardware simulation performance is extremely important for the virtual power-on process and the simulator processing time should be utilized as efficient as possible, there is a need to optimize the sequence of simulator instructions submitted by the simulator request broker to the simulator.

### SUMMARY OF THE INVENTION

It is therefore an object of the present invention, to provide a method to process instruction requests for a digital hardware simulator that is improved over the prior art and an instruction request broker and a corresponding computer program product.

This object is achieved by the invention as defined in the independent claims. Further advantageous embodiments of the present invention are defined in the dependent claims.

The advantages of the present invention are achieved by the introduction of new high-level simulator instruction requests. These high-level simulator instruction requests combine multiple (low-level) simulator instructions and are submitted by a driver to a simulator instruction request broker. Instead of servicing a single driver only, the simulator instruction request broker now queries all active drivers for such high-level simulator instruction requests. The simulator instruction request broker is splitting a received high-level simulator instruction request into a sequence of simulator instructions and stores this sequence in an internal list associated to the driver, its request queue.

The simulator instruction request broker is then processing sequentially the request queues in a round-robin fashion, where the simulator instructions in a request queue are submitted to the simulator. When a simulator instruction was submitted to the simulator, it is removed from the request queue. All the access instructions in a queue will be submitted in sequence to the simulator until a clock instruction needs to be submitted to the simulator. This clock instruction is not submitted and the next queue will be processed until also a clock instruction from this queue needs to be submitted to the simulator.

When there are only clock instructions left that need to be submitted, the simulator instruction request broker determines the minimum number of clock cycles the simulation model is requested to be clocked by the different clock instructions in the request queues. For this minimum number of clock cycles a new clock instruction is created and submitted to the simulator. The different clock instructions in the queues are then modified such that the number of clock cycles is reduced by this minimum number of clock cycles. A clock instruction that had a number of clock cycles equal to this minimum number of clock cycles are removed from the request queues. Then the simulator instruction request broker is querying all active drivers for new high-level simulator instruction requests again.

The introduction of high-level requests allows the simulator instruction request broker to coordinate the different simulator instructions submitted by the various drivers and to submit them in a more efficient manner to the simulator. Especially, the clocking instructions from the various drivers are merged in order to save valuable simulation cycles, while access instructions are concentrated to trigger parallel operations in the hardware simulation.

The clock instructions in the request queues act as synchronization points between the drivers. In one embodiment of the present invention, the simulator request broker is adding variable clock instructions to the request queues in order to prevent drivers from starvation while waiting for the next synchronization point. The time between these synchronization points can be adjusted to optimize simulation performance.

In another embodiment of the invention, a feedback channel exists between the simulator and the simulator request broker that is used by the simulator request broker to analyze the state of the simulation mode. As needed, instructions are added to the request queues to establish this feedback channel. The feedback channel allows using single high-level simulator instruction requests for which feedback from the simulation model influences their execution by the simulator request broker.

### BRIEF DESCRIPTION OF THE DRAWINGS

The present invention and its advantages are now described in conjunction with the accompanying drawings.

FIG. 1: Is a block diagram illustrating a simulation scenario;

FIG. 2: Is a block diagram illustrating a simulation scenario with a simulator instruction request broker;

FIG. 3: Is a block diagram illustrating a simulation scenario with a simulator instruction request broker in accordance with the present invention;

FIG. 4: Is a flow chart illustrating the processing of high-level simulator instruction requests in accordance with the present invention.

### DETAILED DESCRIPTION

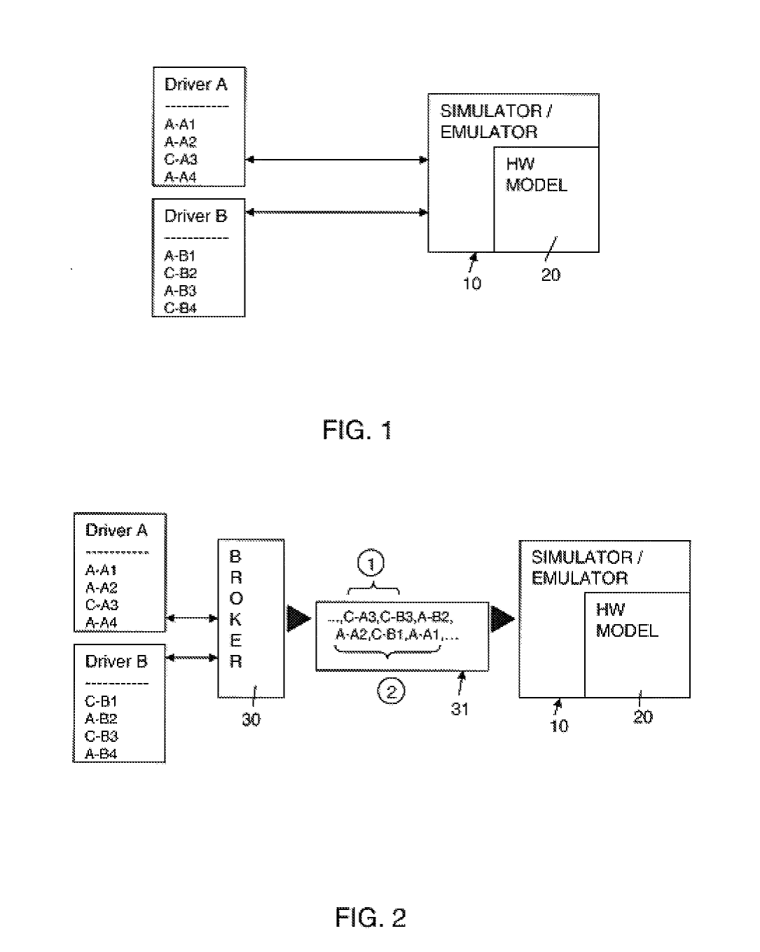

FIG. 1 shows a prior art simulation scenario where a simulator/emulator 10 processes a hardware (HW) model 20. An example for an emulator is the Cadence CoBALT Ultra system. Two drivers A and B control the processing of the HW model 20 via the command interface of the simulator/emulator 10. For the CoBALT Ultra system the command interface is an API provided on an IBM pSeries or IBM RS/6000 workstation that operates as a point of control for the hardware emulator. The command interface can only process one simulator instruction at a time. Only when the execution of a simulator instruction is completed, the next simulator instruction can be processed by the command interface. Instead of using the control interface of the simulator/emulator 10 directly, in the simulation scenario shown in FIG. 2, the drivers A and B use a request broker 30 to control the processing of the HW model 20.

In both simulation scenarios as shown in the FIGS. 1 and 2, the driver A submits the simulator instructions A-A1, A-A2, C-A3, and A-A4 in this sequence to the simulator/emulator 10, and the driver B submits the simulator instructions C-B1, A-B2, C-B3, and A-B4 in this sequence to the simulator/emulator 10. The instructions A-A1, A-A2, A-A4, A-B2, and A-B4 are access instructions. The instructions C-A3, C-B1, and C-B3 are clock instructions. The access instructions comprise GET instructions used to query the current value of a facility in the HW model 20, and PUT instructions used to set a facility in the HW model 20 to a certain value. The request broker 30 distributes the simulator instructions submitted by the drivers A and B to the stream of simulator instructions 31 that is processed by the command interface of the simulator/emulator 10.

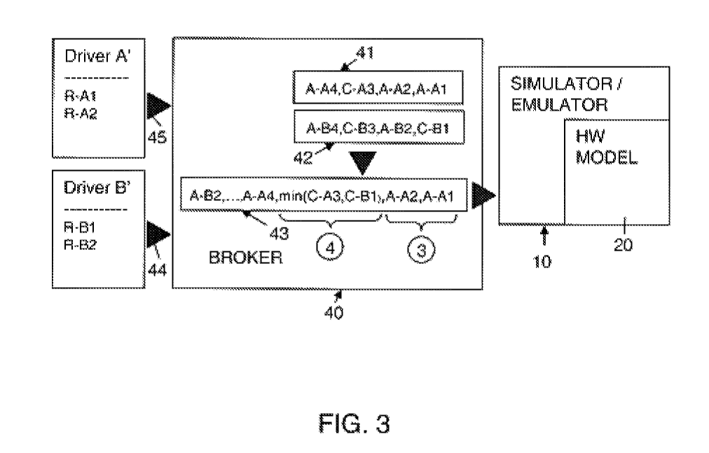

FIG. 3 shows a simulation scenario in accordance to the present invention. The request broker 30 shown in FIG. 2 has been replaced by a new extended request broker 40, and the drivers A and B have been modified to new drivers A′ and B′ that submit new high-level simulator instruction requests R-A1, R-A2 and R-B1, R-B2 respectively instead of simulator instructions. The stream of simulator instructions 31 has been replaced by the simulator instruction stream queue 43 that comprises a sequence of simulator instructions resulting from the high-level simulator instruction requests R-A1, R-A2, R-B1, R-B2.

The drivers A′ and B′ communicate with the request broker 40 over the TCP/IP socket connections 44 and 45 respectively such that the request broker 40 is acting as a server accepting connections from the drivers A′ and B′ acting as clients. The drivers A′ and B′ submit their high-level simulator instruction requests via the socket connections 44 and 45 to the request broker 40. The socket connections 44 and 45 can be realised by a real network connection between different computer systems or by a virtual network connection within a single computer system.

The requests broker 40 offers a special TCP/IP port that can be used by a driver to add itself as a client to the request broker 40. When a new client is added, the request broker creates a new internal request queue associated to that driver and adds a new TCP/IP socket for this driver. The addition of a driver as a client is called the registration of this particular driver. In one embodiment of the invention, the addition of new clients can be performed in a separate thread of execution within the request broker 40.

When the request broker 40 receives a high-level simulator instruction request from one of the drivers A′ and B′ it splits the high-level simulator instruction request to internal representations of simulator instructions that can be processed directly by the simulator/emulator 20. These internal representations of the simulator instructions are stored in the request queue 41 when the high-level simulator instruction request was received from the driver A′ and in the request queue 42 when the high-level simulator instruction request was received from the driver B′.

In the simulation scenario shown in FIG. 3, driver A′ submits the high-level simulator instruction request R-A1 and driver B′ submits the high-level simulator instruction request R-B1, R-A1 is split by the request broker 40 into a sequence of internal representations of the simulator instructions A-A1, A-A2, C-A3, and A-A4 which is then stored in the request queue 41, R-B1 is split by the request broker 40 into the sequence of internal representations of the simulator instructions C-B1, A-B2, C-B3, and A-B4 which is then stored in the request queue 42. Once the request broker 40 finished the reception and splitting of the high-level simulator instruction requests R-A1 and R-B1, it moves internal representations of simulator instructions from the request queues 41 and 42 to the simulator instruction stream queue 43. After this simulator instruction move step, the request broker 40 submits simulator instructions to the simulator/emulator 20 by converting the internal representations stored in the simulator instruction stream queue 43 to the corresponding simulator instructions.

In the simulation scenario shown in FIG. 3, the request broker 40 moves the access instructions A-A1 and A-A2 from the request queue 41 to the simulator instruction stream queue 43. When the request broker 40 detects the clock instruction C-A3 in the request queue 41, it stops moving instructions from this queue and starts moving instructions from the request queue 42 to the simulator instruction stream queue 43 instead. Since the request broker 40 detects the clock instruction C-B1 in the request queue 42, it also stops moving instructions from this queue. The simulator instruction stream queue 43 comprises now the simulator instruction stream segment 3 that is formed by the access instructions A-A1 and A-A2.

Since there are no other request queues associated to drivers than the request queues 41 and 42, the request broker 40 is now determining the minimum number of clock cycles that the clock instructions C-A3 and C-B1 would instruct the simulator/emulator 10 to process for the HW model 20. This minimum number of clock cycles is used by the request broker 40 to generate a new clock instruction min(C-A3, C-B1) for the simulator/emulator 10 that is stored in the simulator instruction stream queue 43, where it forms a new segment 4 in the stream of simulator instructions. The clock instructions C-A3 and C-B1 stored in the request queues 41 and 42 are now modified such that the number of clock cycles is reduced by the minimum number of clock cycles. In case the resulting number of clock cycles is zero for one of the clock instructions C-A3 or C-B1, the entire clock instruction is removed from the request queue 41 or 42 respectively.

The request broker 40 is now submitting the instructions from the simulator instruction stream queue 43 to the simulator/emulator 10. In the present embodiment of the invention, this submission can be performed by a separate thread of execution within the quests broker 40 that submits a simulator instruction only when any instruction submitted previously completed its execution. When a simulator instruction was submitted to the simulator/emulator 10, its internal representation will be removed from the simulator instruction stream queue 43. When the access instructions from the segment 3 have been submitted to the simulator/emulator 10, the clock instruction from the segment 4 is submitted to the simulator/emulator 20.

When the submission of simulator instructions is implemented by a separate thread of execution within the request broker 40, then the processing of receiving and splitting the high-level simulator instruction requests needs to be implemented in another thread of execution within the request broker 40. If there are not separate threads of execution within the request broker 40, the request broker 40 continues to receive high-level simulation instruction requests from the drivers A′ and B′ during the processing of the clock instruction in segment 4, which acts as a synchronization point for the two drivers A′ and B′ then.

The high-level simulation instruction requests are received such that the request broker 40 waits for a high-level simulator instruction request from the driver A′. If the high-level simulator instruction request R-A2 from the driver A′ was received and split, the request broker 40 waits for a high-level simulator instruction request from driver B′. If the request R-B2 was received and split, the request broker 40 stops receiving high-level simulator instruction requests, and starts processing the internal representations of simulator instructions stored in the request queue 41 as described above. During this processing step also the internal representation of the simulator instruction A-A4 will be added to the simulator instruction stream queue 43. Then the request broker continues processing the internal representations of simulator instructions stored in the request queue 42 as described above. During this processing step also the internal representation of the simulator instruction A-B2 will be added to the simulator instruction stream queue 43.

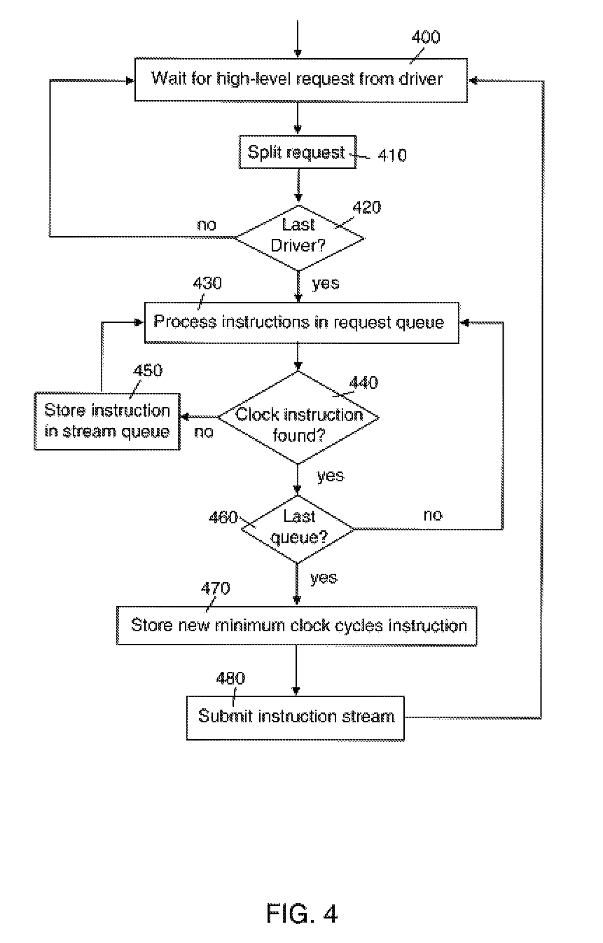

The steps performed by the request broker 40 for the processing of high-level simulator instruction requests submitted by the drivers A′ and B′ can be summarized in a flow chart as shown in FIG. 4. In step 400 the request broker 40 waits for high-level simulator instruction requests submitted by a particular driver. In the preferred embodiment of the invention, a separate thread of execution performs the step 400 and stores the received simulator instruction requests in an additional queue. This way it is not required to stop the processing of high-level simulator instruction requests while waiting for drivers submitting requests. When a high-level simulator instruction request was received by the request broker 40, it splits this high-level simulator instruction request in step 410 into internal representations of simulator instructions that are stored in the request queue that is associated to the particular driver. In the preferred embodiment the steps starting with step 410 are performed in another thread of execution than the thread of execution used for step 410.

If (step 420) there are more drivers registered as clients to the request broker 40, then in step 400 the request broker waits for also for a high-level simulator instruction request submitted by another driver. Otherwise (step 440) the request broker 40 is processing the internal representations stored in a particular request queue in step 430.

If (step 440) the current instruction that is processed by the request broker 40 is not a clock instruction, then the internal representation of the current instruction is moved from the request queue to the instruction stream queue 43. If (step 440) the current instruction is a clock instruction or the request queue is empty, then in step 430 the internal representation of the simulator instructions stored in the next request queue is processed if (step 460) there are request queues that have not been processed by the request broker 40.

If (step 460) all the request queues have been processed by the request broker 40, the minimum number of clock cycles of the clock instructions stored in the top position of the request queues is determined by the request broker 40 in step 470. The request broker 40 generates a new internal representation of a clock instruction for this minimum number of clock cycles and stores this internal representation in the simulator instruction stream queue 43. The number of clock cycles of the clock instructions stored in the top position of the request queues is decreased by this minimum number of clock cycles. If the new number of clock cycles for a clock instruction stored in the top position is equal to 0 now, the internal representation of this instruction is removed from the request queue.

Finally, the instructions for which internal representations are stored in the simulator instruction stream queue 43 are generated, submitted to the simulator/emulator 10, and the internal representations of the submitted simulator instructions will be removed from the simulator instruction stream queue 43. The submission of simulator instructions is stopped by the request broker 40 when a clock instruction was submitted to the simulator 10. Then the request broker 40 continues to receive high-level simulator instruction requests from the drivers in step 400. In the steps 430 to 470 the content of the request queues is merged and stored in the instruction stream queue 43.

In some situations it is not possible to combine simulator instruction requests into high-level simulator instruction requests. A typical case where this is not possible is when the current state of the HW model 20 determines the next simulator instruction to be submitted by a particular driver. An example is the situation when a driver interacts with a component of the HW model 20 that represents an arbitration circuit. Then the arbitration circuit can reject a request controlled by the driver because it is already servicing another request; the other request potentially controlled by another driver. The driver needs to react differently depending on if its request is serviced by the arbitration circuit or not. The following steps give an example:
(1) write register data into SCOM data exchange register;
(2) write “SCOM WRITE” instruction into JTAG instruction register;
(3) clock the hardware emulator;
(4) read SCOM status register and check for command completion;
(5) if status indicates “SCOM IDLE” command is complete;
(6) if status indicates “SCOM BUSY” go back to step (3).

The example shows a possible implementation of a high-level command called SCOM WRITE that can be implemented by a driver. In this example the HW model 20 comprises a circuit that implements an industry standard JTAG (Joint Test Action Group) interface as defined by the IEEE 1149.1 standard. It can be used to write data into hardware configuration registers. For example, in step (1) a write/shift operation comprising of multiple low-level hardware commands will be performed via the JTAG interface.

The individual steps in the example need to be further mapped to simulator instruction requests. A status indication “SCOM BUSY” in the SCOM status register would require one or multiple iterations over the steps (3) to (6). One important aspect is that this loop does not allow predicting the number of simulator instructions needed to implement the SCOM WRITE command.

In order to support also high-level simulator instruction requests that depend on the current state of the HW model 20, a feedback channel between the request broker 40 and the simulator/emulator 10 is established. This feedback channel allows implementing loops and conditional branches for high-level simulator instruction requests. In order to achieve this, a special class of virtual simulator instructions is used by the request broker 40. These virtual simulator instructions are generated and added to a request queue in the step 410, when a high-level simulator instruction request is split by the request broker 40. Instead of being submitted to the simulator/emulator 10 in step 480, a virtual simulator instruction will trigger the creation of new internal representations of simulator instructions (including virtual simulator instructions) by the request broker 40 that are added to the request queue associated to the corresponding driver.

A high-level simulator instruction request submitted by a driver consists of a sequence of bytes, wherein the first 4 Bytes determine the number of bytes, and the next 16 Bytes are used to store the command identifier (ID) string for the high-level simulator instruction request; the remainder of the data are the specific parameter values. An example of such a high-level simulator instruction request is:
LENGTH(uint32)=32;
CMDID=“SCOMWRITE”;
ADDR(uint32)=0xdeadbeef;
DATA(uint64)=0x0123456789abcdef;
   where LENGTH(uint32) specifies the number of bytes of the high-level simulator instruction request, CMDID specifies the command ID string, ADD(uint32) specifies a first parameter that needs to be treated as an unsigned 32 bit value, and DATA(uint64) specifies a second parameter that needs to be treated as an unsigned 64 bit value.

In the preferred embodiment of the present invention the request broker 40 is implemented as a set of C++ classes. For every type of high-level simulator instruction request a corresponding static command class exists that is instantiated by the request broker 40 when it receives a high-level simulator instruction request. The command repository is a special static class that is used by the request broker 40 to register all available command classes. The request broker 40 registers a command class in the command repository such that the command ID and a pointer to the static createCommand member function of the command class instance are stored as an entry in a table in the command repository.

If the request broker 40 receives a new high-level simulator instruction request, it extracts the command ID and looks for this command ID in the table entries stored in the table in the command repository. Then the createCommand function of the associated command class is called via the pointer stored in the table entry. The createCommand function is then creating a new instance of the command class and feeds it with the parameter values from the high-level simulator instruction request. This command class instance also serves as the request queue associated to the driver. Depending on the parameter values the command class instance instantiates further classes, where the corresponding objects represent the simulator instructions in the request queue. A pointer to the command class instance is then also added by the request broker 40 to an internal list of active request queues.

An example for a command class skeleton is shown in the following C++ pseudo code segment:

class HighLevelCommand : public deque<LowLevelInstruction> {
... };
class ScomWrite : public HighLevelCommand {

ScomWrite{uint32 address, uint64 data) {

// add LowLevelInstructions to queue
push_back{PutFac(″ADDRESS_REGISTER″, address));
push_back{PutFac(″DATA_REGISTER″, data));

}

HighLevelCommand* createCommand(...) {

// extract parms “address” and ″data″ and
// create instance of ScomWrite
...
return new ScomWrite(address, data);

}

}
class PutFac : public LowLevelInstruction {

PutFac(string facHandle, uint32 data) {
...
}
void evaluate{ ) {

alter(mFacilityHandle, mData);

}
...

};
class Evaluate : public LowLevelInstruction {

...

};

Every LowLevelInstruction class implements the evaluate member function which is called by the request broker 40 when a LowLevelInstruction object is in the top position of the request queue that is currently processed in step 450. The evaluate function comprises calls to the simulator command interface, which is in this case an API. In the example skeleton above the API function used is the alter(facilityName, facilityData) function.

The instruction stream queue 43 does not need to be implemented, but its effect can be achieved by the way the request broker 40 processes the request queues: For every LowLevelInstruction that does not represent a clock instruction (e.g., marked via a special member variable) its evaluate function is called directly by the request broker from the processing in the request queue.

The command class also contains a prepareResponse function that is called by the instance of the command class, when for all of its LowLevelInstruction objects the evaluate function was called. Then the instance can create the response data that will be sent back by the request broker 40 to the driver originating the corresponding high-level simulator instruction request. The driver needs to know the format of the response data such that it is able to interpret the response data.

The evaluate function can also be used to implement virtual simulator instructions. Since this function is a member of the command class instance, the command class instance serving as a request queue associated to a particular driver can be manipulated. Especially, new LowLevelInstruction objects can be instantiated; hence new internal representations of simulator instructions can be added to the request queue. A new virtual simulator instruction can also be implemented by instantiating new LowLevelInstruction objects.

In one embodiment of the invention, the evaluate function can also be used to split the new clock instruction created in step 470 into multiple clock instructions. This allows preventing drivers from starvation while waiting to submit their next high-level simulator instruction request to the request broker 40 in step 400. These new clock instructions serve then as a synchronization point for the drivers. The right choice for the selection of these synchronization points depends on the simulator/emulator 10 and on the HW model 20 and can be controlled via parameters for the request broker 40 for example.

In one embodiment of the invention, the request queues 41 and 42 comprise an additional indicator that contains a clock cycle number for the HW model 20 that is set by the request broker 40 in step 470. Then in step 430 only those request queues will be processed for which the indicator is smaller or equal to the current clock cycle of the HW model 20. The request broker sets the indicator in step 470 by adding the number of requested clock cycles in the clock instruction request in the top position of the queue to the current clock cycle of the HW model 20 and then removes this clock instruction from the request queue. For the determination of the minimum number of clock cycles in step 470 also the indicator values are taken into account. Then in step 480 the HW model will be clocked by said minimum number of clock cycles.

This invention is preferably implemented as software, a sequence of machine-readable instructions executing on one or more hardware machines. While a particular embodiment has been shown and described, various modifications of the present invention will be apparent to those skilled in the art.

1. A method to process instruction requests for a digital hardware simulator which is connected to at least two simulation drivers,
the method being characterized by the steps of:
receiving simulator instruction requests from each of the drivers;
generating a sequence of instructions for each of the received instruction requests and storing the resulting sequences of instructions in instruction queues associated with the drivers;
merging instructions from said instruction queues;
processing the merged instructions in said hardware simulator.

2. The method of claim 1, wherein said sequences of instructions comprise instructions to an instruction request broker that are processed by said instruction request broker in the merging and/or the processing step.

3. The method of claim 2, wherein the instructions to said instruction request broker can comprise loop and conditional branch instructions and instructions that generate new sequences of instructions.

4. The method of claim 1, wherein the processing step ends when a clock instruction is processed.

5. The method of claim 1, wherein the merging step ends for a particular instruction queue when a clock instruction is in the top position of the instruction queue.

6. The method of claim 5, wherein in the merging step new clock instructions are generated when all of said instruction queues are either empty or have a clock instruction in the top position.

7. The method of claim 6, wherein the new clock instructions comprise a clock instruction with a number of clock cycles that is the minimum number of clock cycles of all the clock instructions in the top position of said instruction queues.

8. The method of claim 6, wherein the new clock instructions comprise a variable number of clock instructions with a variable number of clock cycles, where the numbers depend on the current state of the simulation and on the type of said hardware simulator.

9. An instruction request broker computer program loadable into the internal memory of a digital computer system and comprising software code portions for performing the method according to claim 1 when said instruction request broker is run on said computer.

10. The instruction request broker of claim 9, where the method according to claims 1 is implemented as a framework of classes and an instruction request is mapped to a command class instance.

11. The instruction request broker of claim 10, where the mapping is done using a command repository class having registered all supported command classes in a table, wherein a table entry comprises a command identifier and an address to a static createCommand member function of the associated command class, and the createCommand member function creates an instance of the command class associated to a particular simulator instruction request.

12. The instruction request broker of claim 11, where command class instances serve as said instruction queues associated with a driver each, and wherein the instructions generated in the generation step are request class instances stored in a command class instance.

13. The instruction request broker according to claim 9, where said instruction queues comprise an indicator each that determines if the instructions in an instruction queue will be merged with instructions from other instruction queues.

14. A computer program product comprising a computer-usable medium embodying program instructions executable by a computer, said embodied program instructions comprising the instruction request broker of claim 9.
